(19) United States
(12) Patent Application Publication
(10) Pub. No.: US 2014/0068020 A1
(43) Pub. Date: Mar. 6, 2014

(54) METHOD AND APPARATUS FOR TRANSMITTING AND/OR RECEIVING DATA

(71) Applicant: Samsung Electronics Co., Ltd, Gyeonggi-do (KR)

(72) Inventors: Joo-Hyun Kim, Gyeonggi-do (KR); Hyun-Bin Lee, Seoul (KR)

(73) Assignee: Samsung Electronics Co., Ltd, Gyeonggi-do (KR)

(21) Appl. No.: 14/017,198

(22) Filed: Sep. 3, 2013

(30) Foreign Application Priority Data
Aug. 31, 2012 (KR) 10-2012-0096428

(51) Int. Cl. H04L 29/08

(52) U.S. Cl. CPC H04L 67/02
USPC 709/219

(57) ABSTRACT

A method and an apparatus for transmitting and/or receiving data in an electronic device are provided. In the method, whether a second network is connected is detected while the electronic device cooperates with a server via a first network. When the second network is detected, whether the server is accessible via the second network is determined. When the server is accessible via the second network, the cooperation with the server via the first network is released, and the electronic device is allowed to cooperate with the server via the second network.

### CROSS-REFERENCE TO RELATED APPLICATION(S) AND CLAIM OF PRIORITY

The present application is related to and claims the benefit under 35 U.S.C. §119(a) of a Korean patent application No. 10-2012-0096428 filed in the Korean Intellectual Property Office on Aug. 31, 2012, the entire disclosure of which is hereby incorporated by reference.

### TECHNICAL FIELD

The present disclosure relates to a method and an apparatus for transmitting and/or receiving data in an electronic device.

### BACKGROUND

Recently, an electronic device includes a plurality of network devices for voice communication and data communication. Network functions provided via respective network devices are different in aspects of a bandwidth, a fee, etc., and use a specific network or give a priority to operate depending on user setting. For example, in the case where both a 3rd Generation (3G) network and a Wireless-Fidelity (Wi-Fi) network are available, an electronic device may access a network via a Wi-Fi and download contents or data depending on user setting. For downloading data via a network, the general application uses a publicized method like a Hyper Text Transfer Protocol (HTTP). Also, an electronic device provides a separate download manager service for downloading data to minimize inconvenience generated when the electronic device directly downloads data for each application.

In the case where an application downloads data via a network, the electronic device may select the network via a user and/or the application. When a second network is available while the electronic device is downloading data via a first network, the electronic device may change from the first network to the second network. For example, in the case where Wi-Fi is available while the electronic device is downloading data via a 3G network, the electronic device changes from the 3G network in use to the Wi-Fi network. At this point, the electronic device fails to download via the 3G network. Accordingly, the electronic device requires a method for downloading data even when a network changes.

Also, when data to download exist, the electronic device manages a portion of data using a download standby list with consideration of a bandwidth in order to provide swift download. At this point, when a download standby time gets long more than a predetermined time, session information with a server is removed and the electronic device may not perform a download operation. Generally, the server identifies an electronic device and allows the electronic device to access the server using a session. Accordingly, the electronic device needs to maintain a session with the server for data waiting for a downloading.

### SUMMARY

To address the above-discussed deficiencies of the prior art, it is a primary object to provide at least the advantages described below. Accordingly, an aspect of the present disclosure is to provide a method and an apparatus for transmitting and receiving data in an electronic device.

Another aspect of the present disclosure is to provide a method and an apparatus for transmitting and receiving data depending on network change while an electronic device is transmitting and receiving data in the electronic device.

Still another aspect of the present disclosure is to provide a method and an apparatus for transmitting and receiving data waiting for transmission/reception in an electronic device.

In accordance with an aspect of the present disclosure, a method for transmitting/receiving data in an electronic device is provided. The method includes detecting whether a second network is connected while cooperating with a server via a first network, when the second network is detected, determining whether the server is accessible via the second network, and when the server is accessible via the second network, releasing the cooperation with the server via the first network, and cooperating with the server via the second network.

In accordance with another aspect of the present disclosure, a method for transmitting/receiving data in an electronic device is provided. The method includes detecting connection of a second network while downloading data from a server via a first network, determining whether the server is accessible via the detected second network, and when the server is accessible, stopping the downloading of the data from the server via the first network, and performing downloading the data from the server via the second network.

In accordance with further another aspect of the present disclosure, a method for transmitting/receiving data in an electronic device is provided. The method includes detecting data waiting for a download, determining a connection maintain time of a server corresponding to the data waiting for the download, and requesting an access to the server with consideration of the connection maintain time of the server.

In accordance with further another aspect of the present disclosure, an apparatus for transmitting/receiving data is provided. The apparatus includes at least one processor, a memory, and at least one program stored in the memory and configured for execution by the at least one program, wherein the program includes at least one instruction for detecting whether a second network is connected while cooperating with a server via a first network, when the second network is detected, determining whether the server is accessible via the second network, and when the server is accessible via the second network, releasing the cooperation with the server via the first network and cooperating with the server via the second network.

In accordance with still another aspect of the present disclosure, an apparatus for transmitting/receiving data is provided. The apparatus includes at least one processor, a memory, and at least one program stored in the memory and configured for execution by the at least one program, wherein the program includes at least one instruction for detecting connection of a second network while downloading data from a server via a first network, determining whether the server is accessible via the detected second network, and when the server is accessible, stopping the downloading of the data from the server via the first network, and performing downloading the data from the server via the second network.

In accordance with yet another aspect of the present disclosure, an apparatus for transmitting/receiving data is provided. The apparatus includes at least one processor, a memory, and at least one program stored in the memory and configured for execution by the at least one program, wherein the program includes at least one instruction for detecting data waiting for a download, determining a connection maintain time of a server corresponding to the data waiting for the download, and requesting an access to the server with consideration of the connection maintain time of the server.

Other aspects, advantages and salient features of the disclosure will become apparent to those skilled in the art from the following detailed description, which, taken in conjunction with the annexed drawings, discloses embodiments of the disclosure.

Before undertaking the DETAILED DESCRIPTION OF THE DISCLOSURE below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating an electronic device according to an embodiment of the present disclosure;

FIG. 2 is a detailed block diagram illustrating a processor according to an embodiment of the present disclosure;

FIG. 3A is a view illustrating a system where an electronic device transmits/receives data using a plurality of networks in according to an embodiment of the present disclosure;

FIG. 3B is a view illustrating a system for maintaining an access with a server while an electronic device is waiting for data transmission/reception according to an embodiment of the present disclosure;

FIG. 4A is a flowchart illustrating a procedure for controlling cooperation with a server depending on network change in an electronic device according to an embodiment of the present disclosure;

FIG. 4B is a view illustrating configuration of an electronic device for controlling cooperation with a server depending on network change in the electronic device according to an embodiment of the present disclosure;

FIG. 5A is a flowchart illustrating a procedure for performing data transmission/reception when a network changes while an electronic device transmits/receives data according to an embodiment of the present disclosure;

FIG. 5B illustrates configuration of an electronic device for performing data, transmission/reception when a network changes while the electronic device transmits/receives data according to an embodiment of the present disclosure;

FIG. 6 is a flowchart illustrating a procedure for transmitting/receiving data, depending on network change while an electronic device transmits/receives data according to an embodiment of the present disclosure;

FIG. 7 is a flowchart illustrating a procedure for transmitting/receiving data in an electronic device according to another embodiment of the present disclosure;

FIG. 8A is a flowchart illustrating a procedure for maintaining connection with a server corresponding to data that are waiting for transmission/reception in an electronic device according to an embodiment of the present disclosure;

FIG. 8B is a view illustrating configuration of an electronic device for maintaining connection with a server corresponding to data that are waiting for transmission/reception according to an embodiment of the present disclosure; and

FIG. 9 illustrates a procedure for maintaining connection with a server corresponding to data that are waiting for transmission/reception in an electronic device according to another embodiment of the present disclosure.

Throughout the drawings, like reference numerals will be understood to refer to like parts, components and structures.

### DETAILED DESCRIPTION

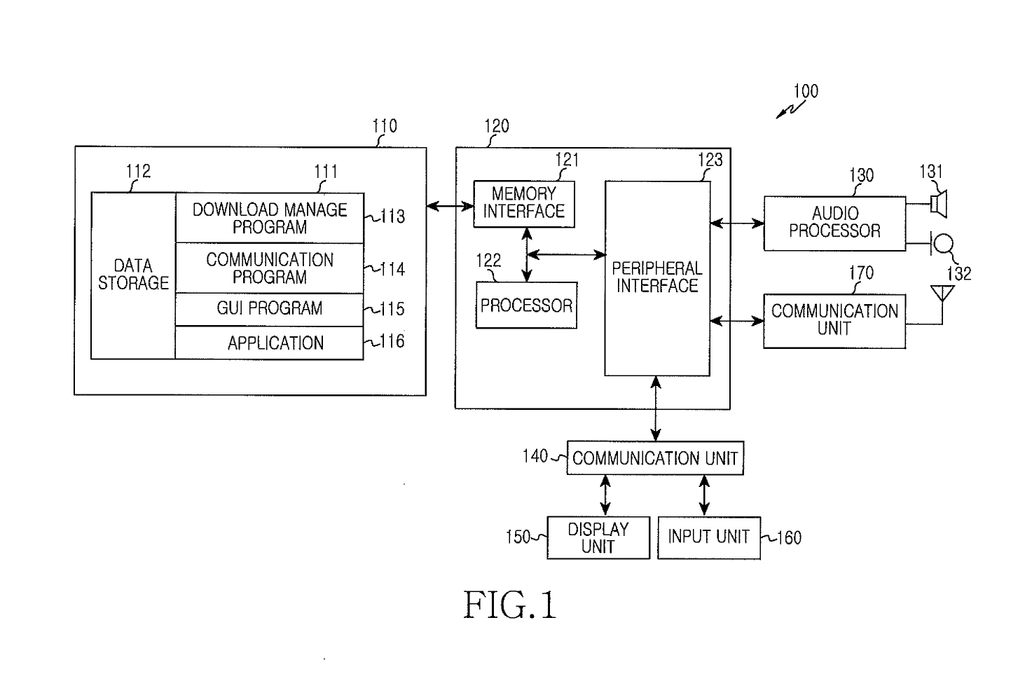

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device. The following description with reference to the accompanying drawings is provided to assist in a comprehensive understanding of embodiments of the disclosure as defined by the claims and their equivalents. It includes various specific details to assist in that understanding but these are to be regarded as merely examples. Accordingly, those of ordinary skill in the art will recognize that various changes and modifications of the embodiments described herein can be made without departing from the scope and spirit of the disclosure. Also, descriptions of well-known functions and constructions are omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of embodiments of the present disclosure are provided for illustration purpose only and not for the purpose of limiting the disclosure as defined by the appended claims and their equivalents.

Example embodiments of the present disclosure provide a technology for controlling data transmission/reception in an electronic device.

In the following description, the electronic device includes a mobile communication terminal, a Personal Digital Assistant (PDA), a laptop, a smart phone, a netbook, a Television (TV), a Mobile Internet Device (MID), an Ultra Mobile Personal Computer (UMPC), a table PC, a navigation, an MP3 player, etc. that provide a communication service.

FIG. 1 illustrates a block diagram of an electronic device according to an embodiment of the present disclosure.

As illustrated in FIG. 1, the electronic device 100 includes a memory 110, a processor unit 120, an audio processor 130, an input/output (I/O) controller 140, a display unit 150, an input unit 160, and a communication unit 170. Here, a plurality of memories 110 may be provided. Each element is described below.

The memory 110 includes a program storage 111 for storing a program for controlling the operation of the electronic device 100, and a data storage 112 for storing data occurring during execution of a program.

The program storage 111 includes a download manage program 113, a communication program 114, a Graphic User Interface (GUI) program 115, and at least one application 116. Here, a program included in the program storage 111 is a set of instructions and may be expressed as an instruction set.

The data storage 112 includes at least one software element for storing connection information. For example, the data storage 112 stores server information for transmitting/receiving data. Here, the server information denotes information received from a server as a response when the electronic device requests data download from the server. In the case where the electronic device transmits “HTTP GET Request” including an item “connection: Keep-Alive” to the server, the server information may include “Keep-Alive: timeout=n” of “HTTP Response” responded from the server. At this point, “Keep-Alive: timeout=n” denotes a time for which the electronic device accesses the server and maintains a session, n denotes second. That is, the session is maintained for n seconds between the server and the electronic device.

The download manage program 113 includes at least one software program for controlling data transmission/reception. For example, when detecting a second network while downloading data from the server via a first network, the download manage program 113 controls to determine whether it can access the server from which the downloading is being performed via the second network. When the server is accessible via the second network, the download manage program 113 may control the data that are being downloaded via the first network to be downloaded via the second network. In case of performing the download via the second network, the download manage program 113 controls to determine whether the download can be performed via the second network from a position subsequent to a position where the download has been completed via the first network. At this point, the download manage program 113 may allow the user to confirm whether to perform the download operation via the second network.

The download manage program 113 includes at least one software element for managing data that are waiting for transmission/reception. For example, when detecting the data that are waiting for being downloaded, the download manage program 113 confirms a server maintain time from the server information corresponding to the data that are waiting for being downloaded. After that, the download manage program 113 controls to periodically request an access to the server with consideration of the access maintain time of the server corresponding to the data that are waiting for a download.

The communication program 114 includes at least one software element for transmitting/receiving data via the communication unit 170. For example, the communication program 114 requests an access to the server using the download manage program 113. For another example, the communication program 114 performs data download from the server using the download manage program 113.

The GUI program 115 includes at least one software element for providing a user interface using graphics on the display unit 150. For example, the GUI program 115 controls to display a menu for allowing the user to confirm whether to change a network and perform download using the download manage program 113 on the display unit 150.

The application 116 includes a software element for at least one application installed in the electronic device 100.

The processor unit 120 includes a memory interface 121, at least one processor 122, and a peripheral interface 123. Here, the memory interface 121, the at least one processor 122, and the peripheral interface 123 included in the processor unit 120 can be integrated in at least one integrated circuit or implemented as separate elements.

The memory interface 121 controls an access of elements like the process 122 or the peripheral interface 123 to the memory 110.

The peripheral interface 123 controls connection between I/O peripheral devices of the electronic device 100 and the processor 122 and the memory interface 121.

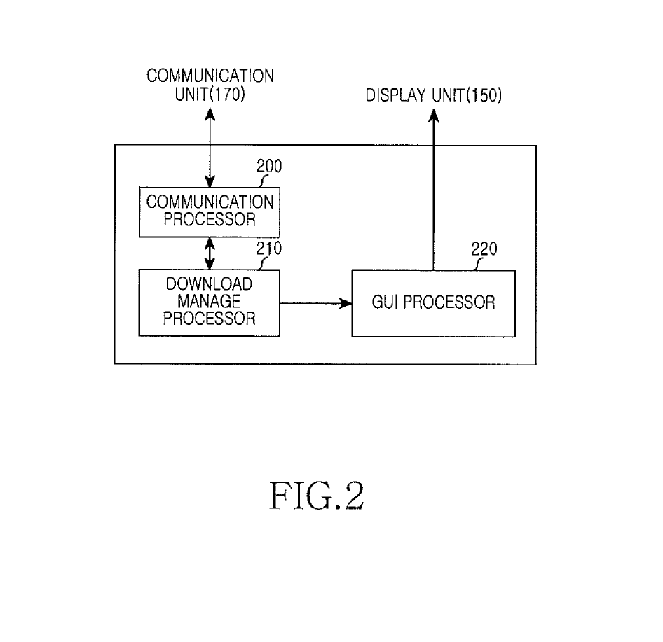

The processor 122 controls the electronic device 100 to provide various multimedia services using at least one software program. At this point, the processor 122 executes at least one program stored in the memory 110 to control to provide a service according to a relevant program. For example, the processor 122 can be configured as illustrated in FIG. 2 in order to execute the download manage program 113 and control data transmission/reception.

The audio processor 130 provides an audio interface between a user and the electronic device via a speaker 131 and a microphone 132.

The I/O controller 140 provides an interface between I/O units such as the display unit 150 and the input unit 160, and the peripheral interface 123.

The display unit 150 displays state information of the electronic device 100, a character input by the user, a moving picture, a still picture, etc. For example, the display unit 150 displays a menu for allowing the user to confirm whether to change a network using the GUI program 115 and perform download.

In the case where the display unit 150 is configured using a touchscreen, the display unit 150 can further include a touch input unit for providing touch information detected via a touch panel to the processor unit 120 via the I/O controller 140.

The input unit 160 provides input data generated by the user's selection to the processor unit 120 via the I/O controller 140. For example, the input unit 160 includes only a control button for controlling the electronic device 100. For another example, the input unit 160 can be configured using a keypad for receiving input data from the user.

The communication unit 170 includes at least one software program for performing a communication function for voice communication and data communication. At this point, the communication unit 170 can be divided into a plurality of communication submodules supporting different communication networks. For example, though not limited thereto, the communication network includes a Global System for Mobile Communication (GSM) network, an Enhanced Data GSM Environment (EDGE) network, a Code Division Multiple Access (CDMA) network, a W-CDMA network, a Long Term Evolution (LTE) network, an Orthogonal Frequency Division Multiple Access (OFDMA) network, a wireless Local Area Network (LAN), a Bluetooth network, Near Field Communication (NFC), etc.

FIG. 2 is a detailed block diagram illustrating a processor according to an embodiment of the present disclosure.

As illustrated in FIG. 2, the processor 122 includes a communication processor 200, a download manage processor 210, and a GUI processor 220.

The communication processor 200 executes the communication program 114 of the program storage 111 to transmit/receive data. For example, the communication processor 200 requests an access to the server using the download manage processor 210. For another example, the communication processor 200 performs downloading data from the server using the download manage processor 210.

The download manage processor 210 executes the download manage program 113 of the program storage 111 to control data transmission/reception. For example, when detecting the second network while downloading data from the server via the first network, the download manage processor 210 controls to determine whether the server from which data, are being downloaded is accessible via the second network. When the server is accessible via the second network, the download manage processor 210 can control data that are being downloaded via the first network to be downloaded via the second network. In case of performing the download via the second network, the download manage processor 210 controls to determine whether the download can be performed via the second network from a position subsequent to a position where the download has been completed via the first network. At this point, the download manage processor 210 can allow the user to confirm whether to perform the download operation via the second network.

The download manage processor 210 executes the download manage program 113 of the program storage 111 to manage data that are waiting for transmission/reception. For example, when detecting the data that are waiting for a download, the download manage processor 210 checks a server maintain time from the server information corresponding to the data that are waiting for a download. After that, the download manage processor 210 controls to periodically request an access to the server with consideration of the access maintain time of the server corresponding to the data that are waiting for a download.

The GUI processor 220 executes the GUI program 114 of the program storage 111 to provide a user interface using graphics on the display unit 150. For example, the GUI processor 220 controls to display a menu for allowing the user to confirm whether to change a network via the GUI processor 220 and perform a download on the display unit 150.

In the above embodiment, the download manage processor 210 of the electronic device executes the download manage program 113 to control data transmission/reception.

In another embodiment, the electronic device can include a separate download processor including the download manage program 113.

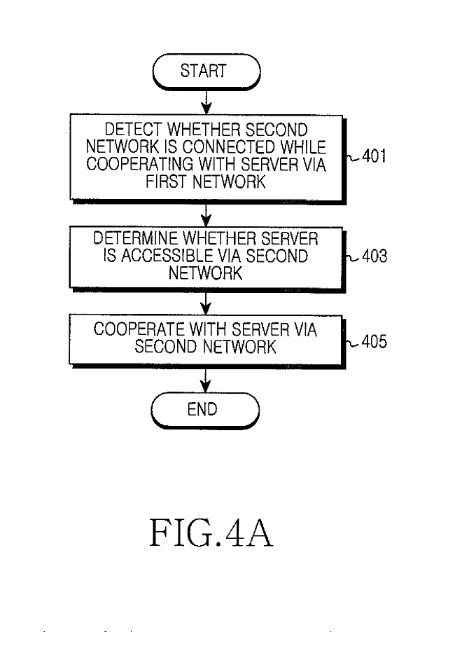

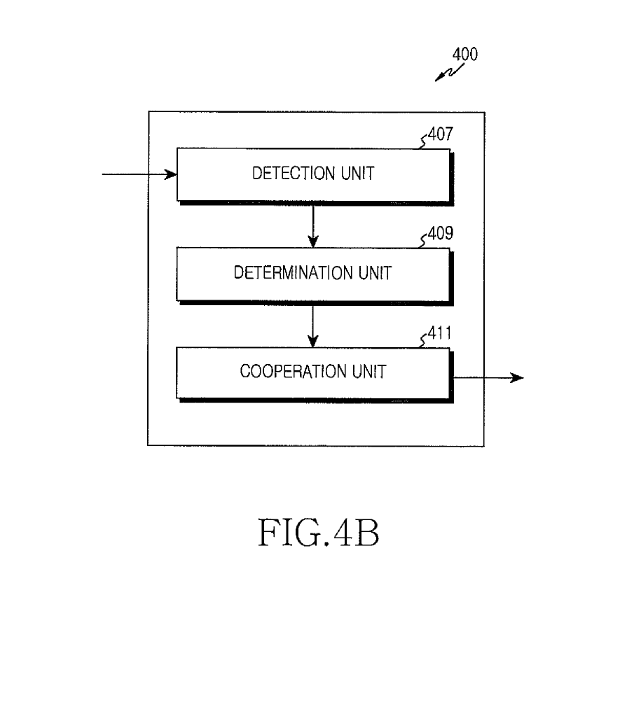

FIG. 4A illustrates a procedure for controlling cooperation with a server depending on network change in an electronic device according to an embodiment of the present disclosure.

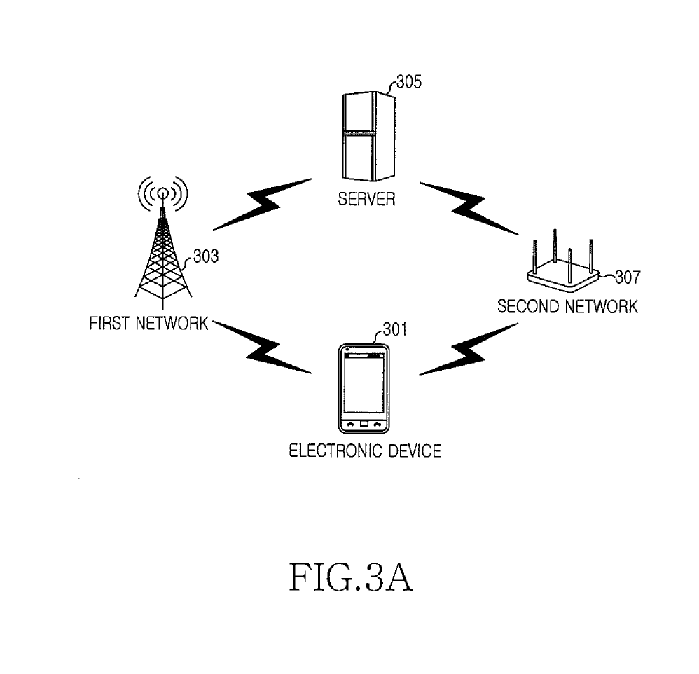

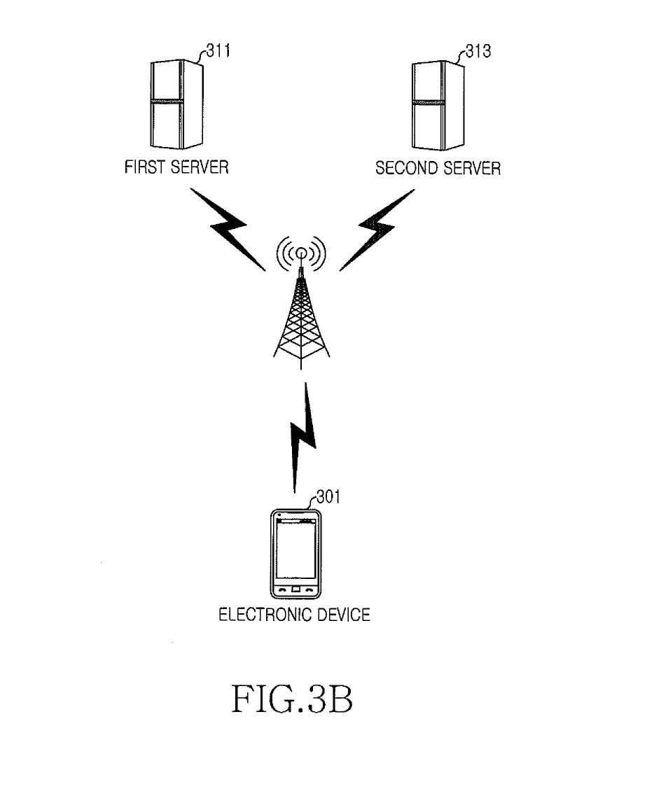

Referring to FIG. 4A, the electronic device detects whether a second network is connected while cooperating with a server via a first network in step 401. For example, as illustrated in FIG. 3A, when the electronic device 301 cooperates with the server 305 via the first network 303, a session is established between the electronic device 301 and the server 305. At this point, the electronic device 301 determines whether the second network 307 is connected. When not detecting the second network, the electronic device ends the present process.

Alternatively, when the second network is connected while cooperating with the server via the first network, the electronic device proceeds to step 403 to determine whether the server is accessible via the second network. For example, as illustrated in FIG. 3A, the electronic device 301 requests the server 305 to determine whether the server is accessible via the second network 307 using session information with the server 305 via the first network 303. At this point, the electronic device 301 transmits “HTTP HEAD Request” to the server 305. When receiving “HTTP 200 OK” from the server 305 as a response as illustrated in FIG. 3A, the electronic device 301 recognizes that the server 305 is accessible via the second network 307.

When the server 305 is accessible via the second network 307, the electronic device proceeds to step 405 to cooperate with the server via the second network. For example, the electronic device ends the cooperation via the first network and performs cooperation with the server via the second network. After that, the electronic device ends the present process.

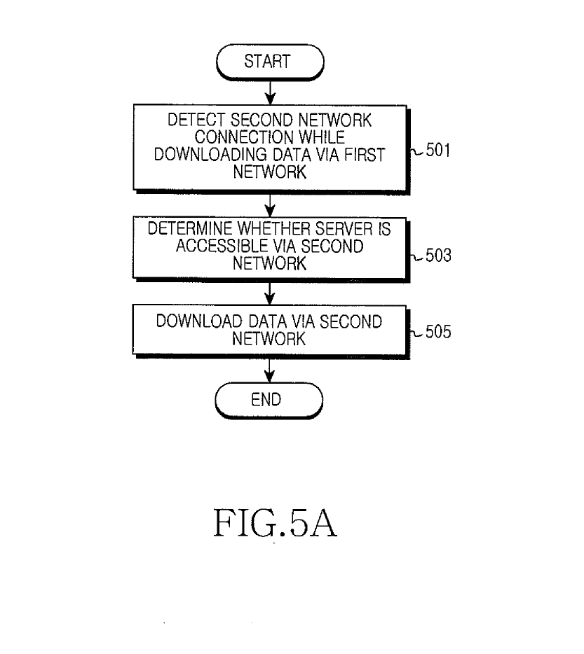

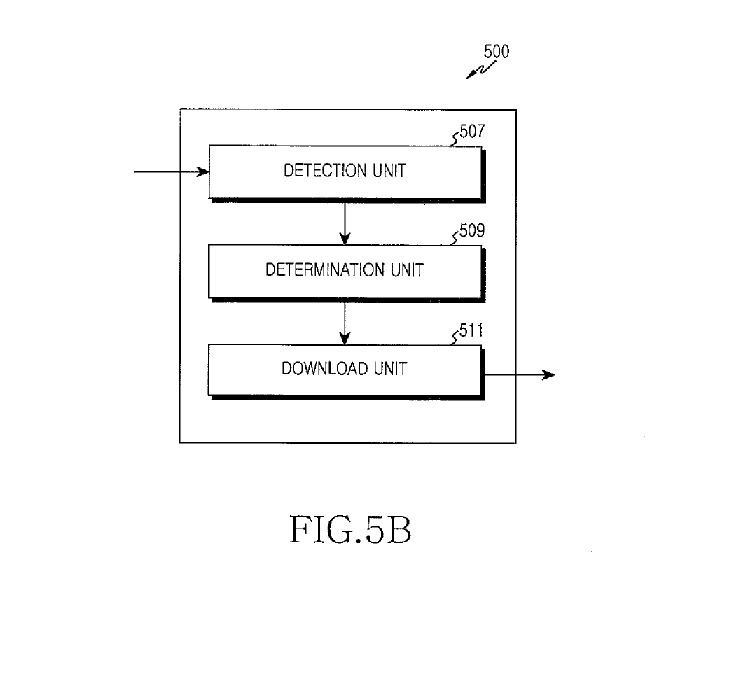

As described above, each procedure for controlling cooperation with the server depending on network change in the electronic device can be configured using means for controlling cooperation with the server depending on the network change in the electronic device as illustrated in FIG. 5B.

FIG. 4B is a view illustrating configuration of an electronic device for controlling cooperation with a server depending on network change in the electronic device according to an embodiment of the present disclosure.

Referring to FIG. 4B, the electronic device has a controller 400 including detection unit 407 for detecting whether the second network is connected while the electronic device cooperates with the server via the first network, determination unit 409 for determining whether the server is accessible via the second network, and cooperation unit 411 for performing cooperation with the server via the second network.

Detection unit 407 detects whether the second network is connected during the cooperation with the server via the first network. For example, as illustrated in FIG. 3A, in the case where the electronic device 301 cooperates with the server 305 via the first network 303, a session is established between the electronic device 301 and the server 305. At this point, the electronic device 301 determines whether the second network 303 is connected. When the second network is not detected, the electronic device ends the present process.

Determination unit 409 determines whether the server is accessible via the second network. For example, as illustrated in FIG. 3A, the electronic device 301 requests the server 305 to determine whether the server 305 is accessible via the second network 307 using session information with the server 305 via the first network 303. At this point, the electronic device 301 transmits “HTTP HEAD Request” to the server 305. When receiving “HTTP 200 OK” from the server 305 as a response as illustrated in FIG. 3A, the electronic device 301 recognizes that the server 305 is accessible via the second network 307.

Cooperation unit 411 cooperates with the server via the second network. For example, the electronic device ends the cooperation with the server via the first network, and performs the cooperation with the server via the second network.

As described above, the electronic device includes respective means for controlling the cooperation with the server depending on the network change. At this point, the respective means for controlling the cooperation with the server depending on the network change can be configured as one means.

FIG. 5A illustrates a procedure for performing data transmission/reception when a network changes while an electronic device transmits/receives data according to an embodiment of the present disclosure.

Referring to FIG. 5A, the electronic device determines whether the second network is detected while downloading data via the first network in step 501. For example, as illustrated in FIG. 3A, when the electronic device 301 accesses the server 305 via the first network 303, a session is established between the electronic device 301 and the server 305. When the electronic device 301 does not respond for a predetermined time, the server 305 ends the session. When the electronic device 301 performs downloading data from the server 305, the electronic device 301 and the server 305 maintain the session. At this point, the electronic device 301 determines whether the second network 307 is detected while downloading data from the server 305. When not detecting the second network, the electronic device ends the present process.

Alternatively, when detecting the second network while downloading data via the first network, the electronic device proceeds to step 503 to determine whether the server is accessible via the second network. For example, as illustrated in FIG. 3A, the electronic device 301 requests the server 305 to determine whether the server 305 is accessible via the second network 307 using session information with the server 305 via the first network 303. At this point, the electronic device 301 transmits “HTTP HEAD Request” to the server 305. When receiving “HTTP 200 OK” from the server 305 as a response as illustrated in FIG. 3A, the electronic device 301 recognizes that the server 305 is accessible via the second network 307.

When the server is accessible via the second network, the electronic device proceeds to step 505 to download data via the second network. For example, the electronic device ends the connection with the server via the first network, and performs downloading data from the server via the second network. At this point, the electronic device 301 transmits “HTTP GET Request” to the server 305. Additionally, when successive downloading via the second network is possible, the electronic device can download data via the second network from a portion where the downloading of the data via the first network has been completed. After that, the electronic device ends the present process.

As described above, the respective procedures for performing data transmission/reception when the network changes while the electronic device transmits/receives data may be configured using means for performing data transmission/reception when the network changes while the electronic device transmits/receives data as illustrated in FIG. 5B.

FIG. 5B illustrates configuration of an electronic device for performing data transmission/reception when a network changes while the electronic device transmits/receives data according to an embodiment of the present disclosure.

Referring to FIG. 5B, the electronic device has a controller 500 including detection unit 507 for detecting the second network while downloading data via the first network, determination unit 509 for determining whether the server is accessible via the second network, and download unit 511 for performing data download via the second network.

Detection unit 507 determines whether the second network is detected while the electronic device downloads data via the first network. For example, as illustrated in FIG. 3A, when the electronic device 301 accesses the server 305 via the first network 303, a session is established between the electronic device 301 and the server 305. When the electronic device 301 does not respond for a predetermined time, the server 305 ends the session. When the electronic device 301 is downloading data from the server 305, the electronic device 301 and the server 305 maintain the session. At this point, the electronic device 301 determines whether the second network 303 is detected while downloading data from the server 305. When not detecting the second network, the electronic device ends the present process.

Determination unit 509 determines whether the server is accessible via the second network in the electronic device. For example, as illustrated in FIG. 3A, the electronic device 301 requests the server 305 to determine whether the server 305 is accessible via the second network 307 using session information with the server 305 via the first network 303. At this point, the electronic device 301 transmits “HTTP HEAD Request” to the server 305. When receiving “HTTP 200 OK” from the server 305 as a response as illustrated in FIG. 3A, the electronic device 301 recognizes that the server 305 is accessible via the second network 307.

Download unit 511 downloads data via the second network in the electronic device. For example, the electronic device ends the connection via the first network, and performs downloading data from the server via the second network. At this point, the electronic device 301 transmits “HTTP GET Request” to the server 305. Additionally, when successive downloading via the second network is possible, the electronic device can download data via the second network from a portion where the downloading has been completed via, the first network.

As described above, respective means for performing data transmission/reception when the network changes while the electronic device transmits/receives data are provided. At this point, the respective means for performing data transmission/reception when the network changes while the electronic device transmits/receives data can be configured as one means.

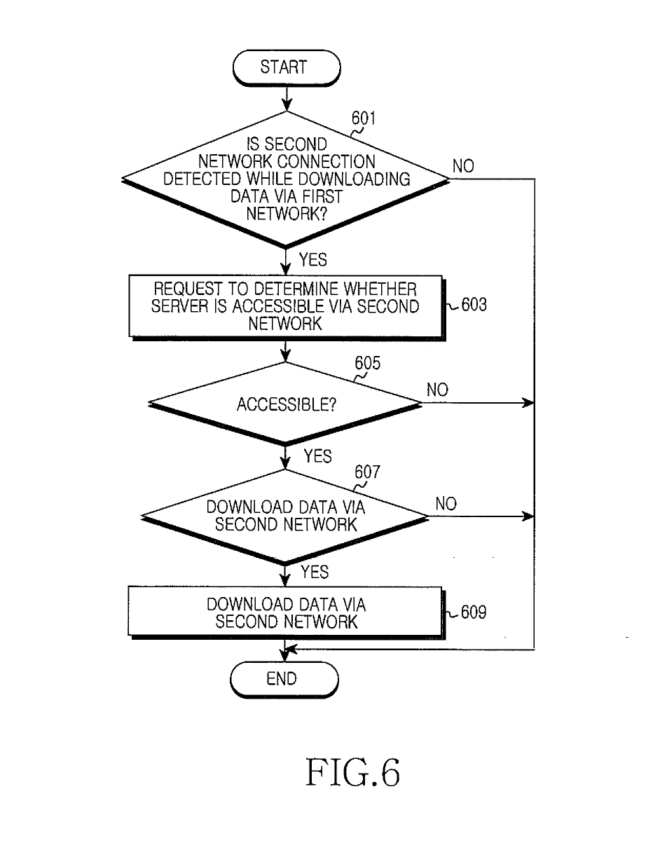

FIG. 6 illustrates a procedure for transmitting/receiving data depending on network change while an electronic device transmits/receives data according to an embodiment of the present disclosure.

Referring to FIG. 6, the electronic device determines whether the second network is detected while downloading data via the first network in step 601. For example, as illustrated in FIG. 3A, when the electronic device 301 accesses the server 305 via the first network 303, a session is established between the electronic device 301 and the server 305. When the electronic device 301 does not respond for a predetermined time, the server 305 ends the session. When the electronic device 301 is downloading data from the server 305, the electronic device 301 and the server 305 maintain the session. At this point, the electronic device 301 determines whether the second network 303 is detected while downloading data from the server 305. When not detecting the second network, the electronic device ends the present process.

When detecting the second network while downloading data via the first network, the electronic device proceeds to step 603 to determine whether the server is accessible via, the second network. For example, as illustrated in FIG. 3A, the electronic device 301 requests the server 305 to determine whether the server 305 is accessible via the second network 307 using session information with the server 305 via the first network 303. At this point, the electronic device 301 transmits “HTTP HEAD Request” to the server 305.

After requesting the server to determine whether the server is accessible via the second network, the electronic device proceeds to step 605 to determine whether the server is accessible. For example, as illustrated in FIG. 3A, when receiving “HTTP 200 OK” from the server 305, the electronic device 301 recognizes that the server 305 is accessible via the second network 307. For another example, as illustrated in FIG. 3A, when receiving “HTTP 503 Forbidden” from the server 305, the electronic device 301 can recognize the server 305 is not accessible via the second network 307. In this case, the electronic device 301 continues to perform downloading data via the first network 303 and ends the present process.

Alternatively, when the server is accessible via the second network, the electronic device proceeds to step 607 to determine whether to download data via the second network. For example, as illustrated in FIG. 3A, in the case where the electronic device 301 has almost completed downloading data via the first network 303, the electronic device 301 does not start the data downloading via the second network 307 again but can complete the data download via the first network 303. At this point, the electronic device 301 can display a confirm window on the display unit 150 in order to determine whether to perform the data downloading via the second network 307. In the case where a user desires to download data continuously via the first network 303, the electronic device ends the present process.

In case of performing the downloading via the second network, the electronic device proceeds to step 609 to end the connection with the server via the first network, and perform downloading data from the server via the second network. At this point, the electronic device 301 transmits “HTTP GET Request” to the server 305. After that, the electronic device ends the present process.

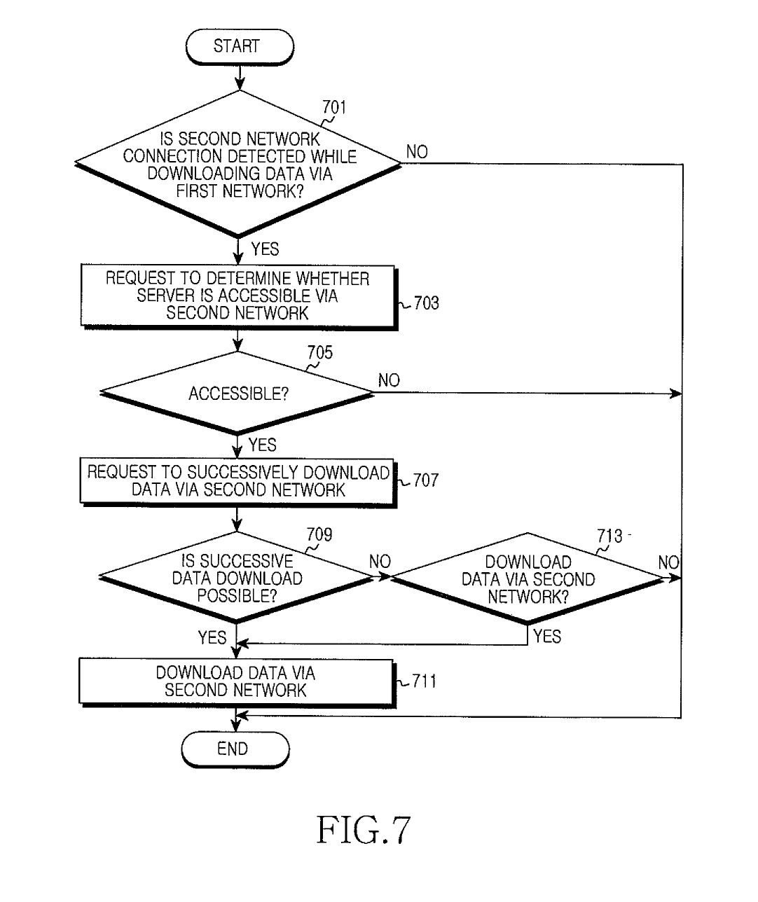

FIG. 7 illustrates a procedure for transmitting/receiving data in an electronic device according to another embodiment of the present disclosure.

Referring to FIG. 7, the electronic device determines whether the second network is detected while downloading data via the first network in step 701. For example, as illustrated in FIG. 3A, when the electronic device 301 accesses the server 305 via the first network 303, a session is established between the electronic device 301 and the server 305. When the electronic device 301 does not respond for a predetermined time, the server 305 ends the session. When the electronic device 301 is downloading data from the server 305, the electronic device 301 and the server 305 maintain the session. At this point, the electronic device 301 determines whether the second network 303 is detected while downloading data from the server 305. When not detecting the second network, the electronic device ends the present process.

Alternatively, when detecting the second network while downloading data via the first network, the electronic device proceeds to step 703 to determine whether the server is accessible via the second network. For example, as illustrated in FIG. 3A, the electronic device 301 requests the server 305 to determine whether the server 305 is accessible via the second network 307 using session information with the server 305 via the first network 303. At this point, the electronic device 301 transmits “HTTP HEAD Request” to the server 305.

After requesting the server to determine whether the server is accessible via the second network, the electronic device proceeds to step 705 to determine whether the server is accessible. For example, as illustrated in FIG. 3A, when receiving “HTTP 200 OK” from the server 305, the electronic device 301 recognizes that the server 305 is accessible via the second network 307. For another example, as illustrated in FIG. 3A, when receiving “HTTP 503 Forbidden” from the server 305, the electronic device 301 can recognize the server 305 is not accessible via the second network 307. In this case, the electronic device 301 continues to perform downloading data via the first network 303 and ends the present process.

When the server is accessible via the second network, the electronic device proceeds to step 707 to request successive downloading via the second network. For example, as illustrated in FIG. 3A, the electronic device 301 transmits “HTTP GET Request” including “Range” item to the server 305 via the second network while maintaining downloading data from the server 305 via the first network 303. At this point, the electronic device 301 can prevent data from being doubly downloaded using “Etag” item.

After requesting the successive downloading via the second network, the electronic device proceeds to step 709 to determine whether successive downloading is possible. For example, as illustrated in FIG. 3A, when receiving “HTTP 206 Partial Content” from the server 305 as a response, the electronic device 301 recognizes that the server 305 provides successive downloading. For another example, as illustrated in FIG. 3A, when not receiving “HTTP 206 Partial Content” from the server 305 as a response, the electronic device 301 can recognize the server 305 does not provide the successive downloading.

When the successive downloading via the second network is possible, the electronic device proceeds to step 711 to end the connection with the server via the first network, and performs downloading data from the server via the second network. At this point, the electronic device downloads data from a portion whose download has been completed via the first network. Additionally, the electronic device can continue to perform downloading data via the first network depending on a user's setting even when successive downloading via the second network is possible.

Alternatively, when the successive downloading via the second network is impossible, the electronic device proceeds to step 713 to determine whether to download data via the second network. For example, as illustrated in FIG. 3A, in the case where the electronic device has almost completed downloading data via the first network 303, the electronic device 301 does not start the data download via the second network 307 again but can complete the data download via the first network 303. At this point, the electronic device 301 can display a confirm window on the display unit 150 in order to determine whether to perform the data downloading via the second network 307. In the case where a user desires to download data continuously via the first network 303, the electronic device ends the present process.

Alternatively, in case of performing the downloading via the second network, the electronic device proceeds to step 711 to end the connection with the server via the first network, and perform downloading data from the server via the second network. At this point, since the successive downloading is impossible, the electronic device performs downloading data from the beginning via the second network. After that, the electronic device ends the present process.

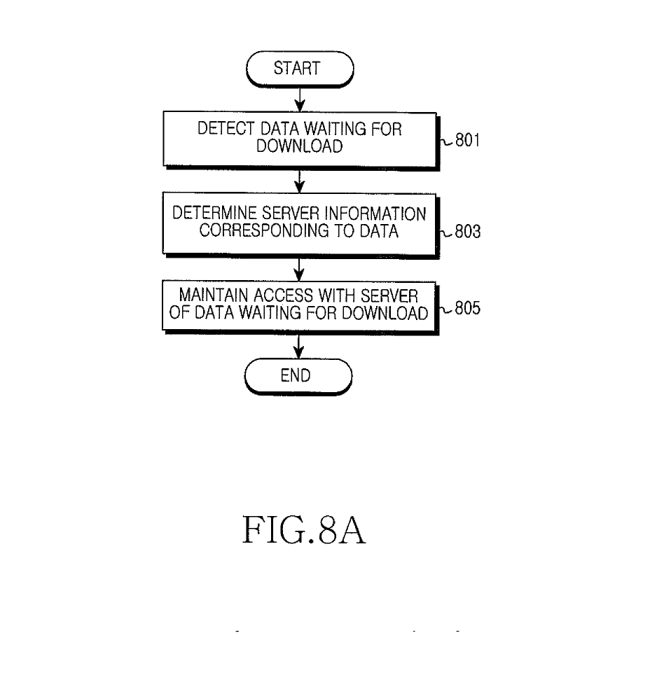

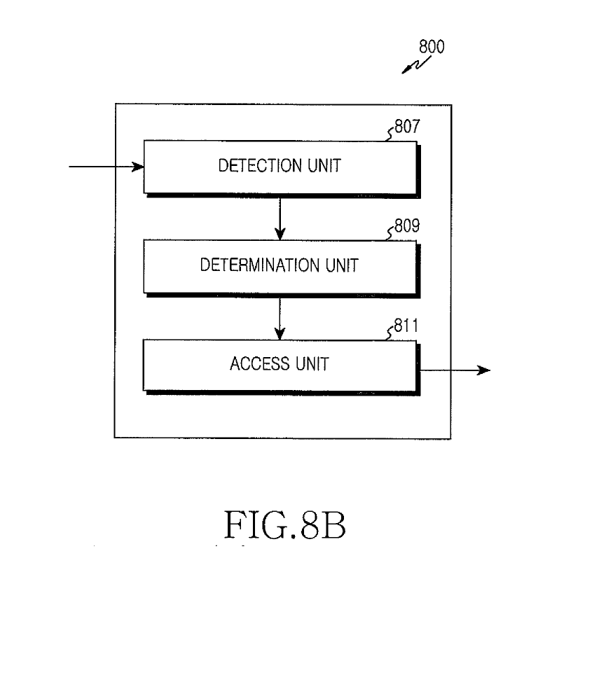

FIG. 8A illustrates a procedure for maintaining connection with a server corresponding to data that are waiting for transmission/reception in an electronic device according to an embodiment of the present disclosure.

Referring to FIG. 8A, the electronic device detects data waiting for a download in step 801. For example, as illustrated in FIG. 3B, the electronic device 301 determines whether data of a second server 313 are waiting for a download while downloading data from a first server 311. Here, it is assumed that the electronic device 301 can download data from the second server 313 after completing downloading data from the first server 311. When data that are waiting for a download do not exist, the electronic device ends the present process.

After detecting data waiting for download, the electronic device proceeds to step 803 to determine a server access maintain time of the data waiting for a download. For example, as illustrated in FIG. 3B, the electronic device 301 determines a session maintain time included in server information of the second server 313. Here, the server information is information responded from the server when the electronic device requests downloading data from the server. In the case where the electronic device transmits “HTTP GET Request” including “connection: Keep-Alive” item, the server information can include “Keep-Alive: timeout=n” of “HTTP Response” responded from the server. At this point, “Keep-Alive: timeout=n” is a time for which the electronic device accesses the server and maintains a session, n denotes second. That is, a session is maintained for n seconds between the server and the electronic device.

After determining the server access maintain time corresponding to data, the electronic device proceeds to step 805 to maintain the access with the server of the data waiting for a download. For example, as illustrated in FIG. 3B, in the case where a session maintain time included in the server information of the second server 313 is 5 seconds, the electronic device 301 determines whether a reference time arrives with consideration of a time at which the server information has been received, the session maintain time, and a transmission delay time. When a period for accessing the server of the data waiting for a download arrives, the electronic device 301 transmits “HTTP HEAD Request” to the second server 313.

Additionally, after requesting an access to the server of the data waiting for a download, the electronic device can determine whether the data waiting for a download is downloaded. When the download of the data waiting for a download is performed, the electronic device ends the present process. After that, the electronic device ends the present process.

As described above, the respective procedures for maintaining the connection with the server corresponding to the data waiting for transmission/reception in the electronic device can be configured using means for maintaining the connection with the server corresponding to the data waiting for transmission/reception in the electronic device as illustrated in FIG. 8B.

FIG. 8B illustrates configuration of an electronic device for maintaining connection with a server corresponding to data that are waiting for transmission/reception according to an embodiment of the present disclosure.

Referring to FIG. 8B, the electronic device have a controller 800 including detection unit 807 for detecting data waiting for a download, determination unit 809 for determining a server access maintain time of the data waiting for a download, and access unit 811 for maintaining an access with the server of the data waiting for a download.

Detection unit 807 detects the data waiting for download in the electronic device. For example, as illustrated in FIG. 3B, the electronic device 301 determines whether data of the second server 313 wait for download while downloading data from the first server 311. Here, it is assumed that the electronic device 301 can download data from the second server 313 after completing downloading data from the first server 311. When data that are waiting for a download do not exist, the electronic device ends the present process.

Determination unit 809 determines a server access maintain time of data waiting for a download in the electronic device. For example, as illustrated in FIG. 3B, the electronic device 301 determines a session maintain time included in the server information of the second server 313. Here, the server information is information responded from the server when the electronic device requests downloading data from the server. In the case where the electronic device transmits “HTTP GET Request” including “connection: Keep-Alive” item, the server information can include “Keep-Alive: timeout=n” of “HTTP Response” responded from the server. At this point, “Keep-Alive: timeout===n” is a time for which the electronic device accesses the server and maintains a session, n denotes second. That is, a session is maintained for n seconds between the server and the electronic device.

Access unit 811 maintains an access to the server of data waiting for a download in the electronic device. For example, as illustrated in FIG. 3B, in the case where a session maintain time included in the server information of the second server 313 is 5 seconds, the electronic device 301 determines whether a reference time arrives with consideration of a time at which the server information has been received from the second server 313, the session maintain time, and a transmission delay time. When a period for accessing the server of the data waiting for a download arrives, the electronic device 301 transmits “HTTP HEAD Request” to the second server 313.

As described above, the respective means for maintaining the connection with the server corresponding to data waiting for transmission/reception in the electronic device are provided. At this point, the respective means for maintaining the connection with the server corresponding to data waiting for transmission/reception in the electronic device can be configured as one means.

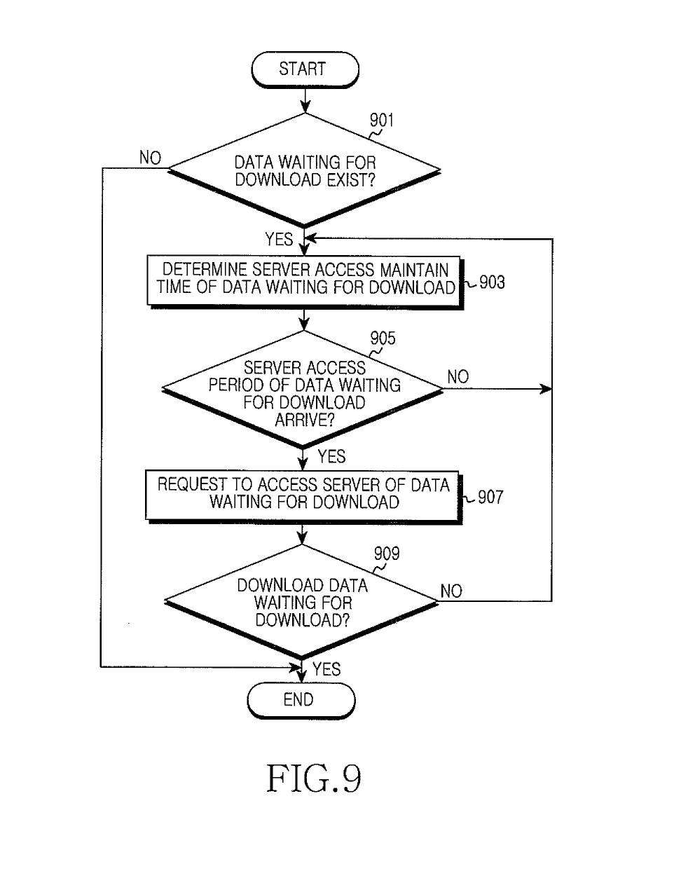

FIG. 9 illustrates a procedure for maintaining connection with a server corresponding to data that are waiting for transmission/reception in an electronic device according to another embodiment of the present disclosure.

Referring to FIG. 9, the electronic device determines whether data waiting for a download exist in step 901. For example, as illustrated in FIG. 3B, the electronic device 301 determines whether data of the second server 313 wait for download while downloading data from the first server 311. Here, it is assumed that the electronic device 301 can download data from the second server 313 after completing downloading data from the first server 311. When data that are waiting for a download do not exist, the electronic device ends the present process.

Alternatively, when the data waiting for a download exist, the electronic device proceeds to step 903 to determine a server access maintain time of the data, waiting for a download. For example, as illustrated in FIG. 3B, the electronic device 301 determines a session maintain time included in server information of the second server 313. Here, the server information is information responded from the server when the electronic device requests downloading data from the server. In the case where the electronic device transmits “HTTP GET Request” including “connection: Keep-Alive” item, the server information can include “Keep-Alive: timeout=n” of “HTTP Response” responded from the server. At this point, “Keep-Alive: timeout=n” is a time for which the electronic device accesses the server and maintains a session, n denotes second. That is, a session is maintained for n seconds between the server and the electronic device.

After determining the server access maintain time of the data waiting for a download, the electronic device proceeds to step 905 to determine whether a period for accessing the server of the data waiting for a download arrives. For example, as illustrated in FIG. 3B, in the case where a session maintain time included in the server information of the second server 313 is 5 seconds, the electronic device 301 determines whether a reference time arrives with consideration of a time at which the server information has been received from the second server 313, the session maintain time, and a transmission delay time.

When a period for accessing the server of the data waiting for a download arrives, the electronic device 301 proceeds to step 907 to request an access to the server of the data waiting for a download. For example, as illustrated in FIG. 3B, the electronic device 311 transmits “HTTP HEAD Request” to the second server 313.

After requesting the access to the server of the data waiting for a download, the electronic device proceeds to step 909 to determine whether the data waiting for a download are downloaded. When the download of the data waiting for a download is performed, the electronic device ends the present process.

Alternatively, when the download of the data waiting for a download is not performed, the electronic device proceeds to step 903 to determine a server access maintain time of the data waiting for a download. After that, the electronic device ends the present process.

As described above, in the case where a network changes while the electronic device transmits/receives data, the electronic device guarantees a user stable data transmission/reception by determining whether it can perform data transmission/reception via the changed network.

Also, the electronic device guarantees download of data waiting for transmission/reception by maintaining a connection (session) with a server corresponding to the data waiting for transmission/reception.

Embodiments of the present disclosure according to the claims and description in the specification can be realized in the form of hardware, software or a combination of hardware and software.

Such software may be stored in a computer readable storage medium. The computer readable storage medium stores one or more programs (software modules), the one or more programs comprising instructions, which when executed by one or more processors in an electronic device, cause the electronic device to perform a method of the present disclosure.

Such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are embodiments of machine-readable storage that are suitable for storing a program or programs comprising instructions that, when executed, implement embodiments of the present disclosure. Embodiments provide a program comprising code for implementing apparatus or a method as claimed in any one of the claims of this specification and a machine-readable storage storing such a program. Still further, such programs can be conveyed electronically via any medium such as a communication signal carried over a wired or wireless connection and embodiments suitably encompass the same.

Although the disclosure has been shown and described with reference to certain example embodiments thereof, it will be understood by those skilled in the art that various changes in form and details can be made therein without departing from the spirit and scope of the disclosure as defined by the appended claims and their equivalents. Therefore, the scope of the present disclosure should not be limited to the above-described embodiments but should be determined by not only the appended claims but also the equivalents thereof.

What is claimed is:

1. A method for transmitting and/or receiving data in an electronic device, the method comprising:
detecting whether a second network is connected while cooperating with a server via a first network;
when the second network is detected, determining whether the server is accessible via the second network; and
when the server is accessible via the second network, releasing the cooperation with the server via the first network, and cooperating with the server via the second network.

2. The method of claim 1, wherein determining whether the server is accessible comprises:
transmitting HTTP Head Request comprising connection information between the first network and the server to the server via the second network; and
determining whether the server is accessible via the second network depending on a response of the HTTP Head Request.

3. The method of claim 2, wherein cooperating with the server via the first network comprises downloading data from the server.

4. The method of claim 3, further comprising:
providing data download information between the first network and the server to the server via the second network; and
receiving response information regarding the data download information provided to the server.

5. The method of claim 4, wherein the data download information comprises an HTTP GET Request message.

6. The method of claim 5, wherein the HTTP GET Request message comprises a Range field value or an ETAG field value regarding a position where downloading of data that is being downloaded from the server via the first network has been stopped.

7. The method of claim 6, further comprising:
when data download is allowed according to the received response information, successively performing downloading from a position where the downloading of the data has been stopped via the second network.

8. The method of claim 5, further comprising:
when data download is allowed according to the received response information, downloading data being downloaded via the first network from a beginning again via the second network.

9. The method of claim 5, further comprising:
when data download is allowed according to the received response information, detecting a final download position of data having been downloaded via the first network; and
downloading data from the server via the second network based on the detected result.

10. The method of claim 9, further comprising:
when a downloaded ratio of the data is equal to or greater than a predetermined threshold, successively downloading data via the second network from a position where downloading of the data from the server via the first network has been stopped.

11. The method of claim 9, further comprising:
when a downloaded ratio of the data is less than a predetermined threshold, downloading the data via, the second network from a beginning again.

12. A method for transmitting and/or receiving data in an electronic device, the method comprising:
detecting connection of a second network while downloading data from a server via a first network;
determining whether the server is accessible via the detected second network; and
when the server is accessible, stopping the downloading of the data from the server via the first network, and downloading the data from the server via the second network.

13. A method for transmitting and/or receiving data in an electronic device, the method comprising:
detecting data waiting for being downloaded;
determining a connection maintain time of a server corresponding to the data waiting for the download; and
requesting an access to the server based on the connection maintain time of the server.

14. The method of claim 13, further comprising:
transmitting HTTP Head Request to the server to initialize the connection maintain time of the server.

15. An electronic device for transmitting/receiving data, the electronic device comprising:
at least one processor;
a memory; and
at least one program stored in the memory and configured for execution by the at least one program,
wherein the program comprises instructions to detect whether a second network is connected while cooperating with a server via a first network, when the second network is detected, determining whether the server is accessible via the second network, and when the server is accessible via the second network, releasing the cooperation with the server via the first network and cooperating with the server via the second network.

16. The electronic device of claim 15, wherein the instructions to determine whether the server is accessible comprise:
instructions to transmit HTTP Head Request comprising connection in formation between the first network and the server to the server via the second network, and determine whether the server is accessible via the second network depending on a response of the HTTP Head Request.

17. The electronic device of claim 16, wherein the cooperation with the server via the first network comprises downloading data from the server.

18. The electronic device of claim 17, wherein the electronic device is configured to provide data download information between the first network and the server to the server via the second network, and receive response information regarding the data download information provided to the server.

19. The electronic device of claim 18, wherein the data download information comprises an HTTP GET Request message.

20. The electronic device of claim 19, wherein the HTTP GET Request message comprises a Range field value or an ETAG field value regarding a position where downloading of data being downloaded from the server via the first network has been stopped.

21. The electronic device of claim 20, wherein when data download is allowed depending on the received response information, the electronic device is configured to successively perform downloading from a position where the downloading of the data has been stopped via the second network.

22. The electronic device of claim 19, wherein when data download is allowed depending on the received response information, the electronic device is configured to perform downloading data that is being downloaded via the first network from a beginning again via the second network.

23. The electronic device of claim 19, wherein when data download is allowed depending on the received response information, the electronic device is configured to detect a final download position of data having been downloaded via, the first network, and download data from the server via the second network in a specific method depending on the detected result.

24. The electronic device of claim 23, wherein when a downloaded ratio of the data is equal to or greater than a predetermined threshold, the electronic device successively downloads data via the second network from a position where downloading of the data from the server via the first network has been stopped.

25. The electronic device of claim 23, wherein when a downloaded ratio of the data is less than a predetermined threshold, the electronic device downloads the data via the second network from a beginning again.

26. An electronic device for transmitting/receiving data, the electronic device comprising:
at least one processor;
a memory; and
at least one program stored in the memory and configured for execution by the at least one program,
wherein the program comprises at least one instruction to detect connection of a second network while downloading data from a server via a first network, determine whether the server is accessible via the detected second network, and when the server is accessible, stop the downloading of the data from the server via the first network, and perform downloading the data from the server via the second network.

27. An electronic device for transmitting/receiving data, the electronic device comprising:
at least one processor;
a memory; and
at least one program stored in the memory and configured for execution by the at least one program,
wherein the program comprises instructions to detect data that are waiting for a download, determine a connection maintain time of a server corresponding to the data that are waiting for the download, and request an access to the server with consideration of the connection maintain time of the server.

28. The electronic device of claim 27, wherein the program further comprises an instruction to transmit HTTP Head Request to the server to initialize the connection maintain time of the server.
